(19) United States
(12) Patent Application Publication
(10) Pub. No.: US 2010/0212852 A1
(43) Pub. Date: Aug. 26, 2010

(54) PAPER FOR LAMINATE FLOORING AND A PROCESS FOR THE MANUFACTURE THEREOF

(76) Inventors: Robin Mansel Mitchell, Somerset (GB); Stephen Nicholas William Cross, Bath (GB)

Correspondence Address: TAFT, STETTINIUS & HOLLISTER LLP, SUITE 1800, 425 WALNUT STREET, CINCINNATI, OH, 45202-3957, US

(21) Appl. No.: 12/672,698

(22) PCT Filed: May 9, 2008
(86) PCT No.: PCT/GB08/01608

§ 371 Date: Feb. 9, 2010

(30) Foreign Application Priority Data
Sep. 5, 2007 (GB) 0708871.9

(51) Int. Cl. D21H 23/00; B32B 3/00

(52) U.S. Cl. 162/164.1

(57) ABSTRACT

A process for the manufacture of a paper suitable for use in a laminated product is described. The process comprising: (a) impregnating the paper preferably on the paper machine with melamine resins dissolved in a solvent, the melamine resins being more than 80% water soluble; the solution having a solids content of less than 50% such that ink may be added to the paper following impregnation. Thus in contrast to established techniques, an ink-pattern is preferably added to the paper after the paper has been treated, preferably impregnated, with resin. In preferred embodiments the paper is calendered after addition of the resins in step (a). The paper can then be further impregnated after printing then combined with a substrate to form a laminated flooring product. Step (a) reduces the wet-expansion caused by the later addition of further resins and is especially useful when step (a) is performed before adding the ink-pattern which then also reduces wet expansion caused by the addition of ink. Embodiments of the present invention are particularly useful for use with embossed or indented laminate flooring designs, where the indentations in the substrate must be matched with the pattern on the paper. The low wet expansion results in a process where less waste can occur and wherein the indentations may be much smaller than conventional laminate flooring allowing more intricate designs to be made.

The present invention relates to paper for laminated flooring, and in particular a process for the manufacture thereof.

Laminate flooring typically comprises a printed decor paper laminated to a base substrate producing a wood or tile effect floor with good durability which is relatively easy to install. The laminate flooring market has seen huge growth in the last 10 years—the annual usage of decor paper for this market is now estimated to be 800 Mm² (globally). Originally this material was produced by the High Pressure Laminate (HPL) process such as that sold under the name Pergo™. This gave an excellent product with extensive guarantees of up to twenty years. However, the High Pressure Laminate (HPL) route is expensive as it involves many layers and requires high pressure.

The development of a low pressure method of manufacturing laminate flooring has driven the commercial success of laminate flooring in recent years. The low pressure process has been refined so as to produce an acceptable product at a much lower cost compared to High Pressure Laminate.

In a conventional low pressure process, plain decor paper is manufactured and then imprinted with a design. Typically there are two or three separate print applications, each adding a different colour of ink. Each print application involves repeated wetting, drying and rewetting of the paper causing the paper to expand and contract each time. For more detailed designs up to six separate print applications can be performed.

The printed paper is then impregnated with a water-based resin, such as conventional melamine formaldehyde resin, which will help protect the final product and also serves to glue the paper to the substrate in the next stage of the process, described below. The resin is dried and cured such that it is dry to touch but not entirely set—this is known as ‘B-stage’ curing. The printed and impregnated paper can then be stored at ambient temperatures before use.

The conventional melamine formaldehyde resins that are used during impregnation are designed to impregnate the voids between the cellulose (paper) fibres. These resins have a relatively low water tolerance so that if diluted with water (from their as supplied concentration of typically 60% solids) they precipitate once they are below 35% solids. The use of 60% solids resins has become widespread in the industry because they are more cost effective (shipping less water), require less drying and can be processed at higher speeds. Molecular weights of such melamine formaldehyde resins are typically in the range of 1000-3000.

The paper is then combined with a substrate in a press, a plate presses the paper onto the substrate and the resin acts to glue the paper to the substrate. A paper overlay (comprising light weight paper impregnated with resins and aluminium dioxide) is normally applied at this time in order to enhance the abrasion protection of the laminated product. A laminated product results with good resistance to wear and abrasion.

Whilst the above produces a reasonable product, the repeated wetting, drying and rewetting of the decor paper during the printing and during the addition of the impregnation resins can be difficult to control thus reducing the accuracy of the intended pattern and requiring strict process control during manufacture.

When the decor paper becomes wet, it expands predominantly across the width of the paper fibres so that, for example, over a dry width of 2 metres, the paper can easily expand to 2.05 metres when wetted (ie equivalent to 2.5%). In addition because the paper is typically formed and dried on a paper machine, the wet expansion is not consistent across the width of the paper and it is higher at the edges than in the centre, for example 3.0% compared to 2.0%. This then leads to a curved wet expansion profile. Further the level of wet expansion can vary by small but nevertheless significant amounts from grade to grade, paper-machine to paper-machine and even within and from batch to batch unless very tight quality control can be achieved.

More recently the manufacturing process has been further developed by the introduction of “emboss in register” designs. In these designs, the laminate is indented which adds depth, and makes the final product appear more realistic. The indented pattern is typically provided by engraving the plate used in the laminating press. Although initial designs were fairly simple more recent designs are becoming increasingly sophisticated.

Crucially the indentations have to align with the printed pattern. The dimensional stability is a particular issue where print, press and cutting register require very tight tolerances to be achieved at each stage of manufacture i.e. printing, impregnation, indenting and cutting the finished panel. In particular the printing and impregnation are very dependant on paper manufacturers producing paper grades with very consistent dimensional stability but even then each process has to be tightly controlled. This leads to high wastage and downtime levels during each production run whilst register and running conditions are optimised. Even then, and despite the above, it has hitherto often not been possible to produce laminate flooring panels to very tight print and press register tolerances due to the inherent variability of the paper.

It would be preferable for a good “emboss in register” effect that the expansion is consistent batch-to-batch, as low as possible and with an even cross-reel profile. Decor paper producers have become more adept at producing papers with more consistent wet expansion within a given batch and to some extent batch-to-batch. However, producing a low wet expansion (less than 1.5%) is very difficult if not impossible with current technology. Known processes also produce an uneven expansion profile. Moreover, the wet expansion characteristics of different paper machines are different and paper processed on different printing and/or impregnating machines can behave differently. It is common that once an “emboss in register” design has been agreed for the final laminate flooring product, then the printer and impregnator are effectively “locked in” to ensure consistent wet expansion throughout the processes.

According to the present invention there is provided a process for the manufacture of a paper suitable for use in a laminated product, the process comprising:
(a) treating, preferably impregnating, the paper with melamine resins dissolved in a solvent, the melamine resins being more than 80% water soluble; the solution having a solids content of less than 50%;
such that ink may be added to the paper following said treatment.

Preferably the paper is a decor paper.

Following step (a) the paper is suitable for use in the printing and impregnation with resins for use as a laminate material.

Preferably the method includes the steps of:
(b) adding an ink-pattern to the paper; then,
(c) treating the paper with resins.

In step (a), preferably the paper is treated in line within a paper machine process that is, the paper is impregnated in line within a paper manufacturing process on a paper machine. This is conducted, for example, either at the wet end, or the size press, but preferably at the size press.

In contrast, conventional melamine impregnation treatment is not performed in line within a paper machine.

The paper is then suitable for combination with a substrate to form laminated flooring.

Thus the invention also provides a process for the manufacture of laminated flooring comprising:
(a) treating the paper with melamine resins dissolved in a solvent, the solution having a solids content of less than 50%;
(b) adding an ink-pattern to the paper; then,
(c) treating the paper with resins; then,
(d) combining with a substrate to form a laminated product.

Typically step (c) involves impregnation with conventional melamine resins.

Preferably the solids content in step (a) is less than 40%, more preferably less than 35%.

All percentages refer to weight percentages unless otherwise stated.

Thus the present invention is clearly distinguished from the known process for the production of paper for laminate flooring which use melamine resins having a solids content of 60 wt % whereas the melamine resins used in step (a) have a solids content of less than 50%.

Preferably the melamine resins used in step (a) are stable in water with the solids content used, which is in any case less than 50%, that is they will not precipitate at the solids content used. The melamine resins are more than 80% water soluble, preferably more than 90% water soluble, especially 100% water soluble and so will ideally mix with water in all concentrations in contrast to the melamine resins that are known for use in impregnation which all have lower water tolerance.

Preferably the melamine resin used has one or more of the following properties:
(i) it does not significantly affect print quality with water based inks, although this is not an issue where step (b) is performed before step (a); and/or,
(ii) it does not significantly interfere with the subsequent rate of melamine resin impregnation in step (c); and/or,
(iii) it does not significantly reduce or otherwise adversely impact (to a significant extent) the drying and gluing properties in step (e) of the resin added in step (c).

Preferably the resins used in step (a) are adapted to penetrate inside fibres of the paper.

Preferably the melamine resins in step (a) comprise alkylated melamine resins having a monomer with the general formula:

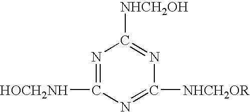

wherein R may be C1-C3, especially C1.

The resin may be a methylated melamine formaldehyde.

Preferably the melamine resins comprise low average molecular weight melamine resins, typically in the range of 750-950, preferably 800-900.

Preferably the melamine resins in the solvent have a solids content of less than 45%, more preferably less than 30 wt %, especially less than 25 wt %. Preferably the solids content is at least 10 wt %, preferably at least 15 wt %, especially at least 20 wt %.

Preferably the solvent is water.

Indeed it was not hitherto considered practical to provide the melamine resins known for use in impregnation in water with a solids content of less than 50% as they are unstable in water at this concentration and will precipitate.

Current impregnating resins are typically used at 60% solids because this provides the required high resin content for Low Pressure while minimizing drying load. These resins are not stable at lower solids contents (because they are very reactive and they are hydrophobic).

In the normal low pressure process, the resins are added after printing and therefore the hardness/brittleness associated with high resin content is not such an issue. In this invention, hydrophilic resins are preferred so as to allow the paper to be printed with water based inks and impregnated with water based resins in later processes. Furthermore the resin in the invention is preferably added before printing for the best results in terms of the integrity of the design (ie the stability of the paper during processing)

Preferably a low pressure process is used and therefore preferably the pressure during step (e) is less than 50 bar, preferably less than 35 bar, typically in the range of 18-30 bar. Alternative embodiments may however use a high pressure process which may be up to 100 bar or more.

Potentially steps (a) and (b) can be conducted in either sequence.

Thus the inventors of the present invention have found that treating the paper with preferably water soluble melamine resins of such a solids content significantly reduces the wet expansion of the paper which will normally undergo wetting, expansion and contraction in step (c).

In the art it is generally accepted that impregnation of resins must occur after the ink-pattern is applied thereto—because of brittleness and handling issues. Contrary to these accepted teachings the inventors of the present invention prefer to add melamine resins before printing. Preferably therefore step (a) is conducted before step (b). This has surprisingly been found to dimensionally stabilise the paper without causing it to become too brittle and impossible to handle in later stages of processing. This results in a significant benefit of dimensionally stabilising the paper before it undergoes the wetting and drying which occurs during step (b), especially since step (b) is normally repeated two or three times and can be repeated up to six times or more. Preferably therefore the step (a) is conducted before step (b) and so offers the further benefit of reducing the expansion and contraction caused by step (b) in addition to reducing the expansion and contraction in step (c).

The percentage of the melamine resin incorporated within the paper resulting from step (a) can be between 5.0 and 20.0% for example. At the upper end of the range, the reduction in subsequent wet expansion is maximised, but the paper becomes relatively hard and brittle which is more difficult to handle once fully cured. In addition print quality is compromised as the resin content is increased. As the amount of resin is reduced, these problems are reduced but the paper will undergo slightly more wet expansion compared to paper with a high content of resins. Thus a preferred optimum concentration to balance these somewhat contrary requirements is for the resin content to be of the order of 10.0 to 15.0% although this can be varied depending on the requirements of the end user.

Preferably a catalyst is added to the melamine resin in step (a).

The catalyst may be any suitable catalyst such as one or more selected from the group consisting of ammonium dihydrogen phosphate, ammonium chloride, ammonium sulphate, citric acid, ammonium citrate, acetic acid, especially ammonium nitrate or ammonium chloride. Preferably the catalyst comprises ammonium nitrate.

Preferably the porosity of the paper following step (a) and prior to step (b) is 240-400 ml/min Bendtsen thus allowing further impregnation to take place.

During and following step (a) the paper is typically cured. This reduces the swelling of the fibres when they are wetted therefore improving the dimensional stability of the paper.

Addition of melamine resins may cause paper to shrink. In preferred embodiments of this invention, the paper is preferably fully cured before step (b), this helps mitigate and sometimes remove the problems of shrinkage. This gives the good dimensional stability in subsequent processes while mitigating any further shrinkage due to resin cure.

The paper temperature during step (a), which is typically performed on a paper machine, preferably reaches a certain minimum in order to trigger cure, preferably at least 60° C. Higher paper temperatures up 70° C. or even up to 95° C., or up to 120° C. or more may be used although higher temperatures, especially above 120° C. increase the danger of the paper being too highly cured and then too hard for effective calendering (thus affecting the important property of print quality).

For certain embodiments, especially those with cure temperatures above 70° C., the paper may be re-wet following curing in order to facilitate calendering before adding an ink-pattern to the paper in step (b).

Preferably the resins are part-cured during step (a).

Preferably the resins are further cured at ambient temperature over a longer period of time such as 1-12 weeks, preferably 2-6 weeks, more preferably 3-5 weeks especially around 4 weeks. The ambient temperature curing step allows the paper to retain some moisture which facilitates calendering and subsequent addition of an ink-pattern to the paper in step (b).

If instead of curing the paper at ambient temperatures for a period of time, heat is used before the addition of an ink-pattern, the paper can lose its moisture and become hard and brittle making printing difficult with less preferred runnability and print definition quality. Preferably the paper has excellent print quality and it preferably is capable of being printed without breaks due to brittleness; thus preferred embodiments include a period of curing at ambient temperatures.

Preferably the paper is calendered between steps (a) and (b).

Following step (c) the paper is typically cured again, typically at a temperature of 105-150° C. to cure the resins used in step (c) until they have reached the normal B-stage degree of curing. Indeed the laminating process in step (e) cures the resins even further when the substrate is combined with the paper.

Typically the curing following step (c) does not affect the resins used in step (a) but rather typically cures the resins added in step (c). Preferably the resins in step (c) are melamine resins.

The resin loading in step (c) is preferably sufficient to give a final resin content of about 60%. Since certain embodiments have 10-15% resin added during the paper production then the resin loading in step (c) need only be 45-50% for such embodiments.

According to a second aspect of the present invention, there is provided a laminate flooring product the surface of the laminate flooring product comprising a substrate and printed decor paper, the substrate having indentations therein, wherein at least some of the indentations have a width of less than 1 mm and the paper design is in register with the indentations.

Thus embodiments according to the second aspect of the invention can produce more detailed emboss in register effects than has hitherto been possible. “In register” here means the design or pattern of the paper is substantially aligned with the indentations.

Preferably the indentations are less than 1.5% of the width of the paper.

Preferably the indentations are less than 0.75 mm, preferably less 0.5 mm.

Embodiments of the present invention will now be described, by way of example only, with reference to the accompanying figures in which:

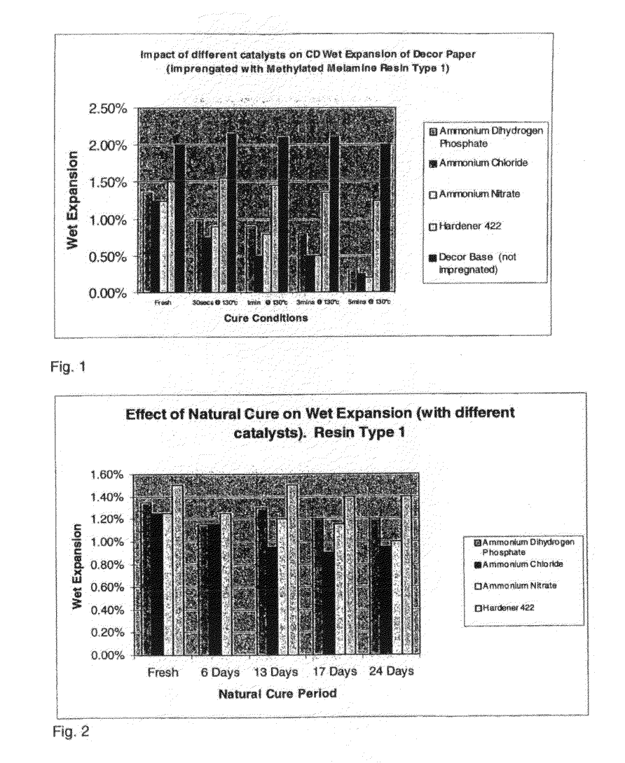

FIG. 1 is a graph showing the wet expansion of a known decor paper and various decor papers subjected to an oven cure and treated in accordance with the present invention;

FIG. 2 is a graph showing the expansion of decor papers subjected to a natural cure and treated in accordance with the present invention;

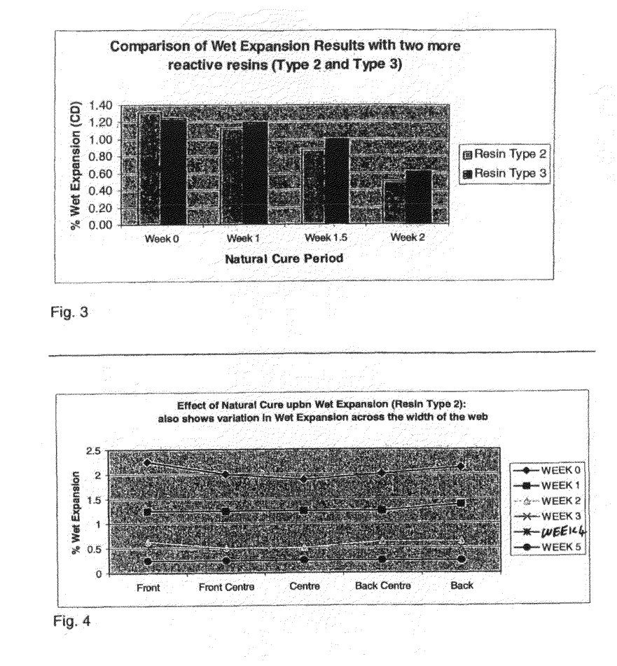

FIG. 3 is a graph comparing wet expansion using different resins, both in accordance with the present invention;

FIG. 4 is a graph showing the wet expansion at different points over the width of a paper web over a period of time;

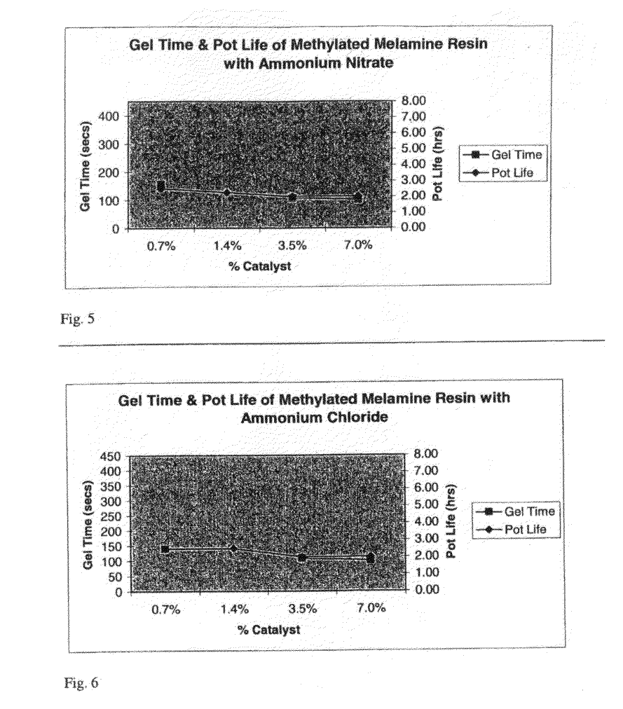

FIG. 5 is graph showing the gel time and pot life of an ammonium nitrate-catalysed resin used in the process of the present invention; and,

FIG. 6 is a graph showing the gel time and pot life of an ammonium chloride-catalysed resin used in the process of the present invention.

In a series of lab experiments, sheets of absorbent base paper were treated with an aqueous solution of methylated melamine resins the solution having a solids content of 10% to give a pick up in the range of 10-15% on the paper grammage. The average molecular weight of the resins used is 820 at manufacture before in situ cross linking.

In a manufacturing process, solids content of around 23% are preferred in order to provide a similar amount of pick up in the range of 10-15% on the paper grammage.

The first resin used (Resin Type 1) was a commercially available methylated melamine resin (low molecular weight, water soluble, very low reactivity) supplied by BASF under the Trade name Urecoll SMV. In each case a different catalyst was added to the methylated melamine resin, the catalysts used were: ammonium dihydrogen phosphate, ammonium chloride, ammonium nitrate, and a hardener (422) supplied by BASF.

The initial impregnation of the paper with the methylated melamine resin in accordance with the present invention is achieved by using a modified size-press in line on the paper-machine and then drying the paper under closely controlled conditions to give a consistent moisture content so that the paper can be calendered to a very smooth surface for printability.

The decor paper used for this impregnation process is manufactured with a sufficient level of wet strength and to a narrow porosity range to give the correct finished porosity (in the range of 250-400 ml per minute) after size-press impregnation and calendering.

The shade and opacity of the paper are also controlled in the same way that a standard, non-impregnated decor paper would be.

The papers were then cured at 130° C. for various times (FIG. 1) and the degree of expansion for each paper was recorded at various time intervals following the cure treatment. These results were compared to a decor paper which had not been impregnated. The non-impregnated paper is described herein for comparison purposes and does not fall within the scope of the present invention. It should be noted that the conventional decor papers are treated with resins only after printing and so it is appropriate to compare the treated papers in accordance with the present invention with a paper which has not been treated with resins whatsoever since the treatment according to the present invention (that is treating the paper with melamine resins dissolved in a solvent, the solution having a solids content of less than 50%) preferably occurs before printing. The results are shown in FIG. 1.

As can be seen from FIG. 1 all papers treated in accordance with the present invention resulted in a reduced degree of wet expansion with the ammonium nitrate catalysed methylated melamine resin performing the best—a wet expansion of just 0.2% occurred after 5 minutes curing at 130° C. which is a significant improvement on the 2% wet expansion recorded for the (untreated) decor paper.

In a separate series of experiments (FIG. 2), the papers were treated as detailed above except the curing regime was changed. Here the papers (apart from the original fresh samples) were lightly dried for fifteen seconds at 105° C. and then left to cure in ambient temperatures. No comparison with untreated decor paper was conducted for this experiment. As can be seen from FIG. 2, a wet expansion of around 1% is observed for the ammonium chloride catalysed methylated melamine resin after twenty four days. Although not shown in FIG. 2, it was also recorded that the wet expansion did reach around 0.6% after around ten weeks. This is a good, low wet expansion level although in preferred embodiments the curing time would be less.

The optimum drying regime for the paper is that at which the resin does not become too hard (ie. too low in moisture content) before the soft bowl calenders (which impart the smoothness required for good print quality) or too damp, in which case resin cure will not be initiated which means it will not mitigate the wet expansion to such a large extent. The methylated melamine resin has to be soluble with at most 50% solids to properly treat the cellulose fibre lumens. Preferably it is completely soluble.

Further experiments were carried out with two different modified methylated melamine resins, based upon the first resin but which were both (i) more reactive and (ii) initiated cure at lower temperatures. The changes were designed to make a product suitable for the paper machine (ie cure initiated at lower temperature) and for the latter processes (final cure achieved within 3-4 weeks). The second resin (Resin Type 2) was BIP DR2573 (available from BIP Resins, Oldbury, England) and the third resin (Resin Type 3) was BIP DR2574 (available from the same supplier).

As detailed below, the second resin was the most reactive, and the third resin had a reactivity between first and second resins. The two resins were impregnated into an absorbent base paper and dried. Then the curing of the resins was monitored over a short period to see if they cured naturally quicker than Resin Type 1 and if they also exhibited a good low level of wet expansion. The results are shown in FIG. 3 where it can be seen that both resins achieve around a 0.6% expansion after just two weeks (compared to ten weeks for Resin Type 1) and that Resin Type 2 has a slightly better (lower) wet expansion level. Resin Type 2 is thus the more preferred resin for use with the present invention.

Resin Type 2 started to cure at 70° C. compared to 100° C. for Resin Type 3 and so was preferred for this reason also. This lower initiation temperature means that the paper can be produced at a higher moisture content and still achieve initial cure while having no detrimental effect upon the soft bowl calendering

In FIG. 4 the wet expansion at the front, front centre, centre, back centre and back of the paper was analysed. In known papers, the expansion varies along its width to produce a curved wet-expansion profile. As can be seen in FIG. 4, the initial (fresh) result, taken in week 0 shows the typical curved profile for wet expansion that known paper would show. (This is also present in the freshly prepared paper even with the resin according to the invention therein because the paper has not yet fully cured.) For Resin Type 2 however, the profile after five weeks is virtually flat.

Thus one benefit of certain embodiments of the present invention is that the paper has a more consistent (as well as low) wet expansion across the web.

FIG. 4 also shows that the final wet expansion of the paper made with Resin Type 2 was lower than that obtained with Resin Type 1 (0.25% compared to 0.6% for Resin Type 1) in tests. This may be due in part to the fact that in the trial with Resin Type 1 the final resin content in the paper was about 13%. The resin content in the trial with Resin Type 2 was 15%. This may account for the slightly lower final wet expansion. This contrasts with known decor papers for use in the production of laminate flooring which have wet expansion in the range of 1.5%-2.5%.

The best range of resin content for optimal performance is 10%-15% for the paper made according to this invention. If the resin content is too low then the wet expansion will not be as low as possible, if the resin content is too great then the paper may become too brittle in latter process stages (eg. printing and impregnating).

Paper manufactured using the Resin Type 2 and ammonium nitrate became fully cured in a reel at ambient temperature within 3 to 4 weeks with a cross direction wet expansion of 0.25% with a completely flat profile. The same paper printed well with no problems.

Results from further experiments are detailed in the table below.

| | | Cross |
|---|---|---|
| | | Direction |
| | | (CD) Wet |
| Paper Grade | Machine direction (MD) | Expansion |
| Expansion (%) | Wet Expansion (%) | (%) |
| Decor Base | 0.55 | 1.45 |
| Original Trial | −0.10 | 0.60 |
| (Resin 1, BASF) | | |
| Latest Trial | 0.05 | 0.20 |
| (Resin 2, BIP) | | |
| 55% Tension | | |
| Latest Trial | 0.07 | 0.17 |
| (Resin 2, BIP) | | |
| 65% Tension | | |

It can be seen from the table that the wet expansion in both the machine direction and the cross direction are significantly reduced for embodiments of the present invention.

Moreover it is noted above that the BIP papers were impregnated with resin under tension and that the paper remained strong and did not tear during this process. Thus a further advantage of certain embodiments of the present invention is that the paper may be impregnated under tension which further reduces the wet expansion of the paper.

With normal decor paper the impregnation stage typically requires the addition of an amount of resin such that the resin added accounts for 60% of the final weight of the paper. For example, taking an 80 g decor base, an additional 120 g of resin is added to give a final weight of 200 g. In this case, the 120 g of resin is 60% of the weight of the final paper.

In contrast, for embodiments of the present invention, whereby resin has been added to the paper before printing, less resin may be added post-printing. For example, for an 80 g decor paper, since this weight already includes some resin, only a further 65 g of resin is required to give a final total weight of 145 g (ie. 80 g paper/resin and 65 g resin). In this case the total resin added at the final stage accounts for 45% of the final weight. Thus as advantage of certain embodiments of the invention is that the addition of resin following printing may be less.

Whilst any resins having a solids content of less than 50% can be used for manufacturing this paper, preferably the higher reactivity methylated melamine resins (coupled with a hardener/catalyst) should be used because they produce better finished results not only in terms of the final level of wet expansion but also the time taken for the paper to cure.

A range of catalysts were tested for their efficacy in the process of the present invention. This range includes ammonium dihydrogen phosphate, ammonium chloride, ammonium sulphate, citric acid, ammonium citrate and acetic acid. The catalyst will have an effect upon the rate of cure of the resin and the life time of the resin system (an important factor in a continuous manufacturing environment).

Whilst all common catalysts will cure the resins according to the present invention, the ideal catalysts are those that are cost effective, are the most labile at the paper machine temperatures, are of neutral pH and give good gel times, ideally 90-120 seconds. Moreover they should not ideally cause the resin system to cross link and therefore harden too quickly and come out of solution. This is often referred to as the “pot life” of the resin, which needs to be a number of hours (preferably at least 2 hours) at normal operating temperatures otherwise the resin becomes unusable in the process. Lastly an ideal catalyst should not adversely affect the downstream processes, in particular the impregnation and subsequent drying. Gel times of less than 80 seconds can give a resin that has too short a pot life because it is too reactive. Note: 150 seconds gel times would normally be too long (too low cure rate)

Two of the best candidates were found to be ammonium nitrate and ammonium chloride. FIG. 5 and FIG. 6 show their pot life and gel time are within the ideal limits set out above.

Ammonium nitrate was chosen because it gave acceptable resin pot life whilst at the same time among the fastest natural cure characteristics. Moreover it is considered more preferred compared to ammonium chloride which potentially causes problems in the downstream impregnation and drying steps.

Thus the benefits of embodiments of the present invention include:
(i) consistency of wet expansion, not just batch-to-batch but also machine-to-machine,
(ii) much lower levels of wet expansion (less than 0.5% for some embodiments) which will allow even more intricate “emboss in register” designs to be produced (eg. detailed square tiles with grouted edges),
(iii) ability to produce paper with a flat wet expansion profile,
(iv) faster impregnation speeds because the paper will not need a full impregnation downstream of the printing; and
(v) reduction in the amount of waste and downtime in the complicated process of producing high detail Emboss-in-Register Laminate Flooring.

Embodiments of the invention thus provide an impregnated decor paper with low molecular weight melamine resins which penetrate the cellulose fibres thus imparting water resistance while not reducing the overall macro absorbency of the paper sheet.

A further advantage of embodiments of the invention is that it provides an impregnated decor paper with higher wet strength which reduces the impact of tension stretching the sheet during impregnation.

A further advantage of embodiments of the invention is that it mitigates or removes the need to produce specially engraved gravure cylinders to relate to the wet expansion of traditional decor paper (both the overall scale and the curved profile).

An advantage of embodiments of the present invention is that resins according to the present invention have the ability to not only coat individual fibres but also to penetrate inside them and then when the resin becomes fully cured it has sufficient strength and resistance to prevent the fibres from swelling, even though the fibres are still able to absorb moisture. This means that, for certain embodiments of the invention, not only do papers manufactured from cellulose fibre treated in this way demonstrate very low levels of expansion when they are immersed in water (<0.5%), ie they have extremely good dimensional stability and thus move very little as the moisture content of the fibre changes. Additionally unlike “normal” paper, the wet expansion profile of certain embodiments of the invention is completely flat.

Thus a particular advantage of preferred embodiments of the invention is that the low wet expansion will allow more intricate designs of embossed laminate flooring to be made, such as having the printed pattern on the paper completely in register, that is aligned, with the pattern of indentations in the press plate, irrespective of the size of the indentation and for some embodiments indentations with a width of less than 1 mm. For example, the grout line on tile designs can now be much narrower and more realistic than possible at present using conventional techniques.

An advantage of embodiments of the present invention is the combination of excellent dimensional stability ie very low levels of wet expansion means that during printing register becomes much less of an issue than with known decor paper because the paper does not move as each layer of water based ink is applied and then dried. When the paper is impregnated, drying the paper is relatively simple because it neither expands nor contracts and does not undergo controlling tension to any significant degree.

An advantage of certain aspects of the present invention is that the resin remains soft enough on the paper machine to allow soft bowl calendering to provide sufficient smoothness for a good print quality.

An advantage of certain embodiments of the present invention is that the resin system that does not greatly affect the subsequent melamine resin impregnation step (after printing) in order to produce a product that is suitable for low pressure pressing onto a substrate.

Improvements and modifications may be made without departing from the scope of the invention.

1. A process for the manufacture of a paper suitable for use in a laminated product, the process comprising:
(a) impregnating the paper with melamine resins dissolved in a solvent to form a solution, the melamine resins being more than 80% water soluble; the solution having a solids content of less than 50%;
such that ink may be added to the paper following said impregnation.

2. A process as claimed in claim 1, further comprising steps (b) and (c), wherein:
(b) comprises adding an ink-pattern to the paper;
(c) comprises treating the paper with resins.

3. A process as claimed in claim 2, wherein step (a) is conducted before step (b).

4. A process for the manufacture of a laminated product comprising a process as claimed in claim 1, wherein the paper has been combined with a substrate to form a laminated product.

5. A process as claimed in claim 4, wherein a pressure during combination of the paper and the substrate is less than 50 bar.

6. A process as claimed in claim 1, wherein in step (a), the paper is impregnated in line within a paper manufacturing process on a paper machine.

7. A process as claimed in claim 2, wherein during and following step (a) the paper is cured, before step (b).

8. A process as claimed in claim 7, wherein a paper temperature during step (a) reaches at least 60° C. in order to trigger cure.

9. A process as claimed in claim 7, wherein the paper is calendered before adding an ink-pattern to the paper in step (b).

10. A process as claimed in claim 1, wherein a solids content in step (a) is less than 40 wt %.

11. A process as claimed in claim 10, wherein the solids content of the solution in step (a) is less than less than 35 wt %.

12. A process as claimed in claim 11, wherein the solids content of the solution in step (a) is less than 25 wt %.

13. A process as claimed in claim 1, wherein a solids content of the solution in step (a) is at least 10 wt %.

14. A process as claimed in claim 13, wherein the solids content of the solution in step (a) is at least 20 wt %.

15. A process as claimed in claim 1, wherein the melamine resins in step (a) comprise alkylated melamine resins having a monomer with the general formula: 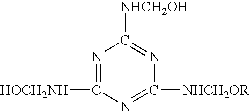
wherein R may be C1-C3, especially C1.

16. A process as claimed in claim 1, wherein the melamine resins in step (a) have an average molecular weight of 750-950, preferably 800-900.

17. A process as claimed in claim 1, wherein the solvent comprises water.

18. A process as claimed in claim 2, wherein the porosity of the paper following step (a) and prior to step (b) is 240-400 ml/min Bendtsen.

19. A process as claimed in claim 1, wherein the percentage of the melamine resins incorporated within the paper resulting from step (a) is between 5.0 and 20.0%.

20. A process as claimed in claim 19, wherein the percentage of the melamine resins incorporated within the paper resulting from step (a) is between 10.0 to 15.0%.

21. A process as claimed in claim 1, wherein a catalyst is added to the melamine resins in step (a).

22. A process as claimed in claim 21, wherein the catalyst is selected from the group consisting of ammonium dihydrogen phosphate, ammonium chloride, ammonium sulphate, citric acid, ammonium citrate, acetic acid, ammonium nitrate and ammonium chloride.

23. A process as claimed in claim 22, wherein the catalyst comprises ammonium nitrate.

24. A process as claimed in claim 1, wherein the melamine resins are cured at ambient temperature over 1-12 weeks, preferably 3-5 weeks.

25. A laminate flooring product, the surface of the laminate flooring product comprising a substrate and printed decor paper, the substrate having indentations therein, wherein at least some of the indentations have a width of less than 1 mm and the paper design is in register with the indentations.

26. A laminate flooring product as claimed in claim 25, wherein the indentations are less than 1.5% of the width of the paper.

27. A laminate flooring as claimed in claim 25, wherein the indentations are less than 0.75 mm.

28. A laminate flooring product as claimed in claim 25, wherein the indentations are less than 0.5 mm.
